(19) United States
(12) Patent Application Publication
(10) Pub. No.: US 2025/0105334 A1
(43) Pub. Date: Mar. 27, 2025

(54) METHOD OF ASSEMBLING A BATTERY CELL

(71) Applicant: Northvolt AB, Stockholm (SE)

(72) Inventor: Abhinav Sharma, Västerås (SE)

(21) Appl. No.: 18/886,310

(22) Filed: Sep. 16, 2024

(30) Foreign Application Priority Data
Sep. 27, 2023 (SE) 2351112-4

(51) Int. Cl. H01M 10/04; H01M 50/107; H01M 50/249; H01M 50/593; H01M 50/595

(52) U.S. Cl. CPC H01M 10/0431; H01M 10/0422; H01M 50/107; H01M 50/249; H01M 50/593; H01M 50/595

(57) ABSTRACT

A method of assembling a battery cell comprising: receiving a jelly-roll comprising an anode layer, a cathode layer and at least one separator layer between the anode and cathode layer, the jelly-roll comprising a substantially cylindrical body having a first end, at which one or more cathode layer connectors project that couple to the cathode layer, and a second end, opposed the first end; applying at least an insulation tape, comprising an electrically insulating tape, around the cylindrical body such that a first part of the insulation tape winds around the cylindrical body to, at least in part, hold the jelly-roll in a rolled state, and a second part of the insulation tape overhangs the first end; and folding the second part of the insulation tape to at least partially cover the first end.

### CROSS-REFERENCE TO RELATED APPLICATIONS

This application claims priority to and the benefit of Swedish Application No. 2351112-4, filed Sep. 27, 2023; the contents of which as are hereby incorporated by reference in their entirety.

### BACKGROUND

### Related Field

The present disclosure relates to a method of assembling a battery cell. It also relates to a battery cell formed by such a method.

### Related Art

A jelly-roll, or Swiss roll, is a cell structure commonly used in the assembly of secondary cells. A jelly-roll is a type of electrode assembly having a structure in which an anode layer and a cathode layer, each comprising a long conductive sheet or foil coated with an active material, are wound with a separator layer interposed in-between. The wound assembly therefore has a cylindrical or ‘roll’ shape. The jelly-roll is placed into a can, which forms the casing for the battery cell, along with a plurality of other components. The plurality of other components provide for one or more of sealing of the jelly roll in the can, insulating the jelly-roll from the can, and allowing for an electrical connection to be formed between the jelly-roll and battery cell terminals.

Improving the efficiency of battery cell assembly presents a challenge.

### BRIEF SUMMARY

According to a first aspect of the present disclosure there is provided a method of assembling a battery cell comprising: receiving a jelly-roll comprising an anode layer, a cathode layer and at least one separator layer between the anode and cathode layer, the jelly-roll comprising a substantially cylindrical body having a first end, at which one or more cathode layer connectors project that couple to the cathode layer, and a second end, opposed the first end; applying at least an insulation tape, comprising an electrically insulating tape, around the cylindrical body such that a first part of the insulation tape winds around the cylindrical body to, at least in part, hold the jelly-roll in a rolled state, and a second part of the insulation tape overhangs the first end; and folding the second part of the insulation tape to at least partially cover the first end.

In one or more embodiments, receiving the jelly-roll comprises: winding, with a winding apparatus, a layered assembly of the anode layer, the cathode layer and the at least one separator layer to form the jelly-roll; and wherein applying at least the insulation tape comprises wrapping the first part of the insulation tape around the cylindrical body.

In one or more embodiments, the first part of the insulation tape extends over 30% to 100% of the cylindrical body of the jelly-roll.

In one or more embodiments, receiving the jelly-roll further includes applying one or more fixing tapes around cylindrical body after the winding of the layered assembly to prevent unwinding of the jelly-roll, wherein the one or more fixing tapes are of a different material to the insulation tape.

In one or more embodiments, the insulation tape and the one or more fixing tapes are unwound from respective spools and applied to the jelly-roll concurrently.

In one or more embodiments, the one or more fixing tapes comprise one fixing tape and the method comprises: applying said one fixing tape around the cylindrical body proximal the second end to prevent unwinding of the jelly-roll.

In one or more embodiments, the method comprises: applying a first fixing tape of the one or more fixing tapes around the cylindrical body proximal the second end to prevent unwinding of the jelly-roll; applying a second fixing tape of the one or more fixing tapes around the cylindrical body proximal the first end to prevent unwinding of the jelly-roll; and wherein the first part of the insulation tape is non-overlapping with the second fixing tape.

In one or more embodiments, the first part of the insulation tape is non-overlapping with the one or more fixing tapes that prevent unwinding of the jelly-roll.

In one or more embodiments, the method comprises, prior to folding the second part, welding an electrically conductive cathode disc to the one or more cathode layer connectors; and, wherein the folding of the second part of the insulation tape comprises folding the second part of the insulation tape over the cathode disc to electrically insulate at least a circumferential portion of the cathode disc.

In one or more embodiments, after the folding of the second part of the insulation tape over the cathode disc, inserting the jelly-roll into a can without further electrical insulation provided between the electrically insulated circumferential portion of the cathode disc and the can.

In one or more embodiments, after the folding of the second part of the insulation tape over the cathode disc, inserting the jelly-roll into a can with a cathode disc insulator between the electrically conductive cathode disc and the can.

In one or more embodiments, the method comprises, after folding the second part, welding an electrically conductive cathode disc to the one or more cathode layer connectors that are uncovered by the folded second part.

In one or more embodiments, the method comprises: receiving a tray comprising one or more holders, each holder configured to receive a respective jelly-roll and defined by a base and one or more side walls; and inserting the jelly-roll into a respective one of the one or more holders, such that it stands on its first end within the holder and at least the second part of the insulation tape electrically insulates the one or more cathode layer connectors from the holder; transporting the jelly-roll in the tray to a subsequent assembly step.

In one or more embodiments, the subsequent assembly step includes: removing the jelly-roll from the holder; and welding an electrically conductive cathode disc to the one or more cathode layer connectors.

In one or more embodiments, the method includes at least one of: the one or more fixing tapes are of polypropylene and the insulation tape is of polyimide.

In one or more embodiments, the method comprises applying the insulation tape with the winding apparatus that wound the layered assembly to form the jelly-roll.

According to a second aspect of the disclosure we provide a battery cell comprising: a jelly-roll comprising an anode layer, a cathode layer and at least one separator layer between the anode and cathode layer, the jelly-roll comprising a substantially cylindrical body having a first end at which one or more cathode layer connectors project that couple to the cathode layer and a second end, opposed the first end; and at least an insulation tape, comprising an electrically insulating tape, around the cylindrical body such that a first part of the insulation tape winds around the cylindrical body to, at least in part, hold the jelly-roll in a rolled state, and a second part of the insulation tape is folded to at least partially cover the first end.

According to a third aspect of the disclosure we provide a vehicle including a battery system comprising the battery cells or assembled with use of the method as described herein. The vehicle may comprise a battery electric vehicle and the battery system may be configured to provide motive power.

A further aspect of the disclosure may comprise a battery system comprising the battery cell or assembled with use of the method as described herein, wherein the battery system comprises a battery energy storage system, such as grid-connected battery energy storage system. In other examples, the battery system comprises part of a trailer or roof-box for coupling to a vehicle.

While the disclosure is amenable to various modifications and alternative forms, specifics thereof have been shown by way of example in the drawings and will be described in detail. It should be understood, however, that other embodiments, beyond the particular embodiments described, are possible as well.

The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an exploded view of a cylindrical battery cell and jelly-roll as well as typical other components;

FIG. 2 show a flow chart illustrating an example embodiment of the disclosure;

FIG. 3 shows a schematic representation of a first example embodiment of a jelly-roll secured against unwinding by a first, electrically insulating, tape;

FIG. 4 shows an example process flow diagram illustrating assembly of the jelly-roll of FIG. 3 for subsequent insertion in a can;

FIG. 5 shows a schematic representation of a second example embodiment of a jelly-roll secured against unwinding by a first, electrically insulating, tape;

FIG. 6 shows an example process flow diagram illustrating assembly of the jelly-roll of FIG. 5 for subsequent insertion in a can;

FIG. 7 shows a schematic representation of a third example embodiment of a jelly-roll secured against unwinding by a first, electrically insulating, tape;

FIG. 8 shows an example process flow diagram illustrating assembly of the jelly-roll of FIG. 7 for subsequent insertion in a can;

FIG. 9 shows an example embodiment of securing an electrically conductive cathode disc to the cathode layer connectors and folding an insulation tape around the conductive cathode disc; and

FIG. 10 shows an example embodiment of a process step in which the jelly-roll assembly is loaded into a holder for transport to a subsequent assembly step.

### DETAILED DESCRIPTION

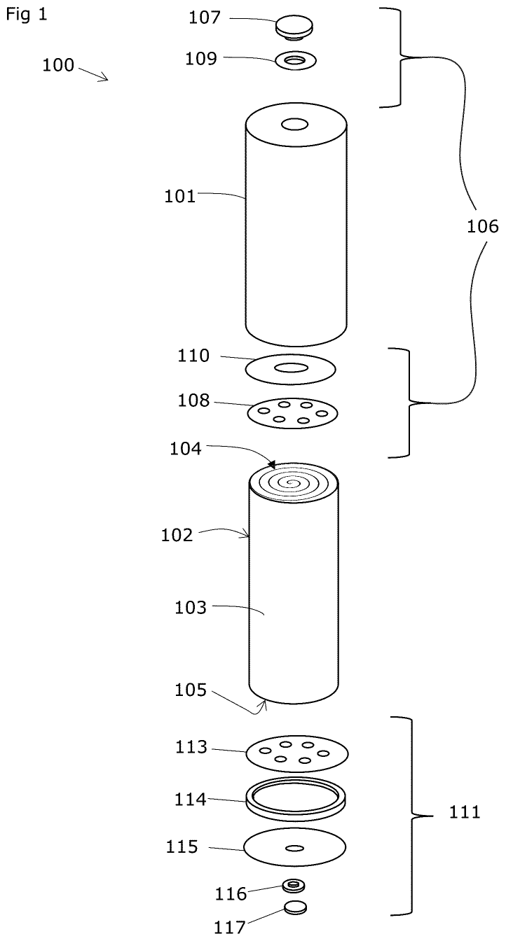

FIG. 1 shows an exploded diagram of a typical cylindrical battery cell 100 to show its internal structure. The battery cell 100 comprises a substantially cylindrical casing, known in the art as a can 101, and a cylinder-shaped electrode roll assembly, known in the art as a jellyroll 102, which is received within the can 101. In some example embodiments, the can 2 is also filled with a liquid electrolyte (not shown).

The jelly-roll 102 comprises a layered assembly of an anode layer, a cathode layer and at least one separator layer between the anode and cathode layer, each comprising a long conductive sheet or foil coated with an active material, as well as the aforementioned active materials. Once the layers are wound together, the jelly-roll 102 comprises a substantially cylindrical body 103 having a first end 104 and a second end 105, opposed the first end 104.

The first end 104 may include one or more cathode layer connectors (not shown) that project from the cathode layer. The cathode layer connectors provide for electrical coupling of the jelly-roll 102 to a respective terminal. The one or more cathode layer connectors may comprise cathode tabs or part of the cathode layer. The second end 105 may include one or more anode layer connectors or anode tabs (not shown) that project from the anode layer. The anode layer connectors or tabs provide for electrical coupling of the jelly-roll 102 to a respective terminal.

FIG. 1 also shows a plurality of first end components 106 that are either secured to the first end 104 of the jelly-roll 102 by one or more assembly steps or inserted into the can 101 with the jelly-roll 102.

An aspect of this invention relates to a method of assembly of the jelly-roll and, optionally, the provision of the first end components 106 and the associated assembly steps. However, before we describe the method, we will describe the typical first end components 106 and second end components 111 of a known design.

The first end components 106 comprise a rivet 107 which is configured to close the can at the cathode, first end. The rivet 107 also acts as a positive battery terminal for the cell. The rivet 107 is configured to be electrically coupled, such as by welding, to an electrically conductive cathode disc 108 that electrically connects to the cathode layer connectors of the jelly-roll 102 and is received within the can 101. A rivet gasket 109 is provided for sealing between the rivet/battery terminal 107 and the can 101. A cathode disc insulator 110 provides for electrical insulation between the cathode disc 108 and the inside surface of the can 101. In some examples, the cathode disc insulator 110 has a flange to electrically insulate a part of the cylindrical part 103 directly adjacent the first end 104 of the jelly-roll.

The second end components 111, for a known design, comprise an anode disc 113 which is provided to connect to the anode tabs (such as copper flags) of the jelly-roll and act as a current collector. A lid gasket 114 is provided over the anode disc to provide for sealing of a lid 115 which closes the second end of the can 101. A seal plug 116 is provided to seal the can 101 by slotting into an aperture in the lid 115. A seal cap 117 finally closes the cell.

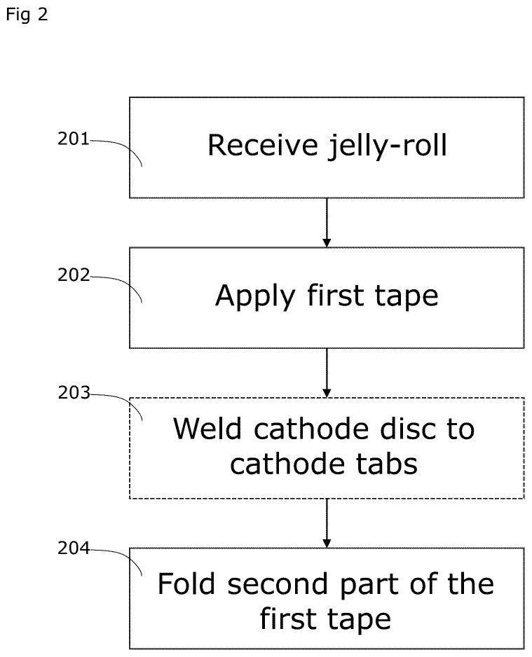

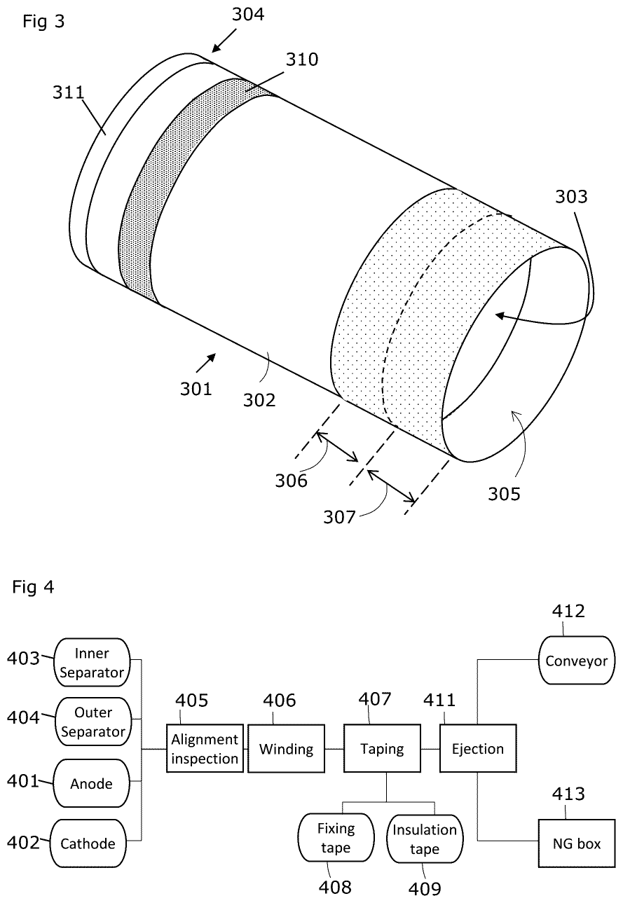

With reference to FIG. 2 and FIG. 3, we will now describe a first embodiment of the disclosure.

In general, we disclose a method of assembling a cylindrical type battery cell comprising the steps of receiving 201 a jelly-roll 301, wherein the jelly-roll comprises a substantially cylindrical body 302 having a first end 303, at which one or more cathode layer connectors project that couple to the cathode layer, and a second end 304, opposed the first end 303. The jelly-roll is substantially the same as the known jelly-roll described in relation to FIG. 1.

The jelly-roll 301 may be received on a mandrel of a winding apparatus which winds the anode layer, cathode layer and at least one separator layer together into the jelly-roll form. Alternatively, the jelly-roll 301 may have been removed from the mandrel of the winding apparatus and may be received on a conveyor or otherwise transported. The step 201 may include loading the jelly-roll 301 onto a further mandrel (or more generally a further winding apparatus for rotation of the jelly-roll) for application of an insulation tape and, optionally, one or more fixing tapes, as will be described below. However, a preferred embodiment comprises receiving the jelly-roll 301 on the mandrel of the winding apparatus that wound the layered assembly, which obviates the need for additional transportation/process steps.

The method comprises applying 202 an insulation tape 305 around the cylindrical body 302. In the embodiments described herein, one piece of the insulation tape 305 is applied but in other embodiments at least one insulation tape 305 is applied. The insulation tape 305 comprises an electrically insulating tape, such as a polyimide tape, although other materials may be used. The insulation tape 305 may have a thickness of around 20-40 micrometres, such as 32 micrometres. The insulation tape is applied circumferentially around the jelly-roll 301 such that a first part 306 of the width of the insulation tape 305 winds around the cylindrical body 302. The first part 306 acts, at least in part, to hold the jelly-roll 301 in a rolled state and thereby prevent unrolling of at least the first end 303. A second part 307 of the width of the insulation tape 305 overhangs the first end 303. The insulation tape 305 may extend circumferentially over the whole circumference of the jelly-roll 301. The second part 307 of the width may extend beyond the layers that form the jelly-roll 301 and may surround or encircle at least part or all of the cathode layer connector(s) (not shown). Thus, the cathode layer connector(s) may lie within a volume defined by the overhanging second part 307 or, alternatively, the second part 307 may overhang by a lesser amount and the cathode layer connectors may project further than the overhanging second part 307.

The method then includes folding 204 the second part 307 of the insulation tape 305 to at least partially cover the first end 303 and any component placed against the first end, as will be described. By folding 204 the overhanging second part 307 radially inwardly the insulation tape electrically insulates the cylindrical body 302 proximal the first end 303 and at least part of the first end 303.

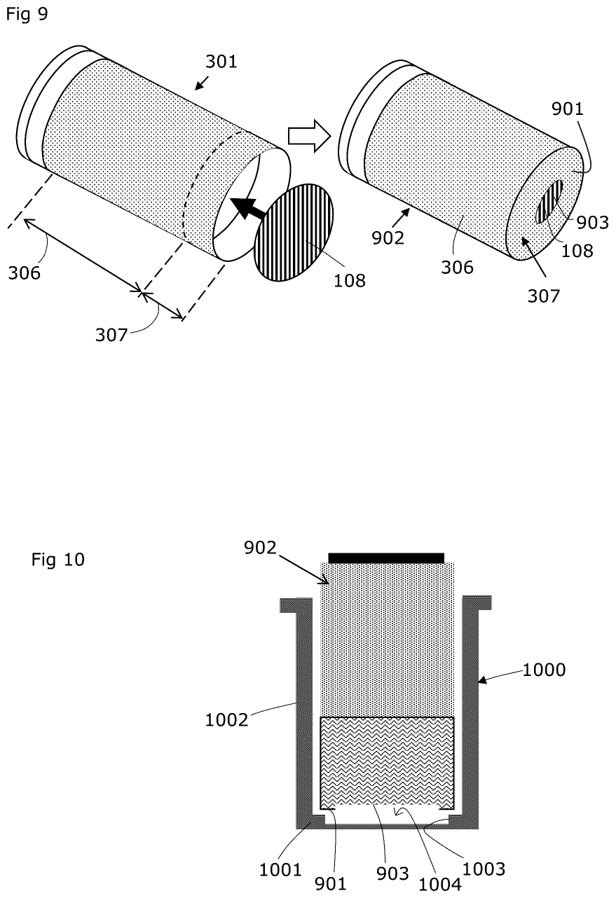

The method may comprise, prior to folding 204 of the second part 307, welding 203 an electrically conductive cathode disc 108 (shown also in FIG. 9) to the one or more cathode layer connectors. Thus, the electrically conductive cathode disc 108 may be inserted into the volume defined by the overhanging second part 307 and welded to the cathode layer connectors. Alternatively, the welding of the electrically conductive cathode disc to the one or more cathode layer connectors may occur prior to the application of the insulation tape 305.

Thus, the folding 204 of the second part of the insulation tape 305 comprises folding the second part 307 of the insulation tape 305 over the cathode disc to electrically insulate at least a circumferential portion of the cathode disc. The cathode disc may be electrically insulated for ease of handling in subsequent assembly steps and/or from the can when the jelly-roll assembly, that is the jelly-roll 302, the insulation tape and the cathode disc 108, is loaded into the can.

The folding 204 of the second part 307 may be such that the second part of the insulation tape 305 lies against an outwardly facing face of the cathode disc 108. This may reliably insulate a circumferential edge of the cathode disc 108 and at least part of its face. More generally, the folding 204 of the second part 307 may be such that the second part of the insulation tape 305 is folded to one or more of: contact and lie against an end of the jelly-roll 301; contact and lie against free edges of the one or more cathode layer connectors; contact and lie against the cathode disc 108, if present; contact and lie against an end of a tab-less jelly-roll; and lie substantially perpendicular to an axis of the jelly-roll 302.

The method of the disclosure may include, after the folding 204 of the second part 307 of the insulation tape 305 over the cathode disc 108, and any subsequent steps, inserting the jelly-roll into a can without further electrical insulation provided between the electrically insulated circumferential portion of the cathode disc 108 and the can.

In an alternative example, the method may comprise folding 204 of the second part 307 over the first end 104, and subsequently welding 203 the electrically conductive cathode disc 108 (shown also in FIG. 9) to the one or more cathode layer connectors. Thus, the electrically conductive cathode disc 108 may be applied to the first end 104 over the folded part of the insulation tape 305 and a part of the first end uncovered by the insulation tape 305 and welded to the cathode layer connectors that are not covered by the folded part.

Application of the insulation tape 305 and then folding the second part 307 around the first end to at least partly cover the cathode layer connectors makes handling of the jelly-roll much easier. The jelly-roll may be transported for cathode disc welding with the folded second part 307 electrically insulating the cathode layer connectors. The cathode layer connectors that are not covered by the folded second part 307 can then be welded to the conductive cathode disc 108.

The introduction of the application of electrically insulating tape onto the jelly-roll during the winding process is advantageous because it allows for simpler assembly. The insulation tape, when folded over the first end, electrically insulates at least a circumferential portion of the first end making handling the jelly-roll easier by reducing the risk of unintended electrical connections and, optionally, obviates the need for further electrically insulating components 110 in the can. Thus, the method of assembly described herein will enable a reduction in assembly time, equipment, cost & material for the assembly of, in particular, cylindrical large format type cell.

As briefly mentioned above, the jelly-roll 301 may be formed by winding, with a winding apparatus (not shown), a layered assembly of the anode layer, the cathode layer and the at least one separator layer to form the jelly-roll. The applying of the insulation tape 305 may comprises wrapping or winding the first part 306 of the insulation tape around the cylindrical body. The winding of the insulation tape may be performed by the same winding apparatus that formed the jelly-roll, which may receive the insulation tape 305 from an associated spool. Alternatively, the jelly-roll 301 may be transported and mounted on a further winding apparatus (not shown). The insulation tape 305 may be wound onto the jelly-roll 301 as described above from a spool, then cut to length and secured around the cylindrical body 302. Alternatively, the insulation tape may be cut to length before winding onto the cylindrical body 302.

With reference to FIGS. 3 and 4, FIG. 3 shows an example embodiment of the jelly-roll with the insulation tape 305 applied. FIG. 4 shows an example process flow diagram for assembling the jelly-roll of FIG. 3.

In this example, the jelly-roll 301 further includes a fixing tape 310 applied circumferentially around the cylindrical body 302 proximal the second end 304. The fixing tape 310 may be of a different material to the insulation tape 305. For example, the fixing tape may be of polypropylene, although other materials may be used. The fixing tape may have a thickness of between 20 and 45 micrometres, such as 32 micrometres. The fixing tape 310 is configured to hold the layers of the jelly-roll together and prevent unwinding of the jelly-roll and, in particular, unwinding of at least the part of the jelly-roll proximal the second end 304.

FIG. 3 shows a plurality of anode tabs 311 projecting from the second end 304. The fixing tape 310, in this example, is non-overhanging of the second end 304 (or first end) and is applied inward of the second end 304 and inward of the anode tabs 311.

The fixing tape 310 may be applied in the same process step or at the same station on a production line as the insulation tape 305. Thus, the insulation tape 305 and the fixing tape 310 may be unwound from respective spools and applied to the jelly-roll 302 concurrently at the same station.

The ends of the fixing tape 310 and/or the insulation tape 305 may be fixed by an acrylic adhesive layer applied on the respective tape.

FIG. 4 shows provision of the anode layer 401, the cathode layer 402 and, in this example, an inner separator layer 403 and an outer separator layer 404. The layers are placed together to provide the layered assembly, which may be provided to an alignment inspection process 405.

The layered assembly may then be provided to a winding process 406 in which the winding apparatus receives the layered assembly on a mandrel and winds the layered assembly to form the jelly-roll 301.

A tape application process 407 receives the fixing tape 310 from a first store or spool 408 and receives the first, insulation, tape 305 from a second store or other spool 409. The tape application process 407 applies the insulation tape 305, or insulation tape 305 and fixing tape 310 to the jelly-roll. The same winding apparatus or mandrel may be used for the tape application process 407 as the winding process 406.

The jelly-roll is ejected at process step 411 where it may be forwarded to either a post-winding conveyor 412 or a “not good” box or conveyor 413.

In one example, the winding apparatus “station” may have a plurality of positions. The winding apparatus may comprise at least one mandrel mounted on a winding turret wherein movement, such as rotation, of the winding turret moves the mandrel of the winding apparatus to the plurality of positions. For example, with the mandrel at a first position, the winding apparatus may be configured to wind the layered assembly and may provide for anode layer and cathode layer cutting. At a second position, which may be adopted by rotation of the winding turret of the winding apparatus, the one or more separator layers may be cut and the insulation tape 305 and/or fixing tapes 310 are applied. The winding turret may rotate such that the mandrel of the winding apparatus adopts a third position. At the third position the jelly-roll with end tape is removed from the mandrel, such as by a gripper, and sent to a conveyor or otherwise transported. In other examples, a further winding apparatus mandrel position may be provided for application of the insulation tape 305.

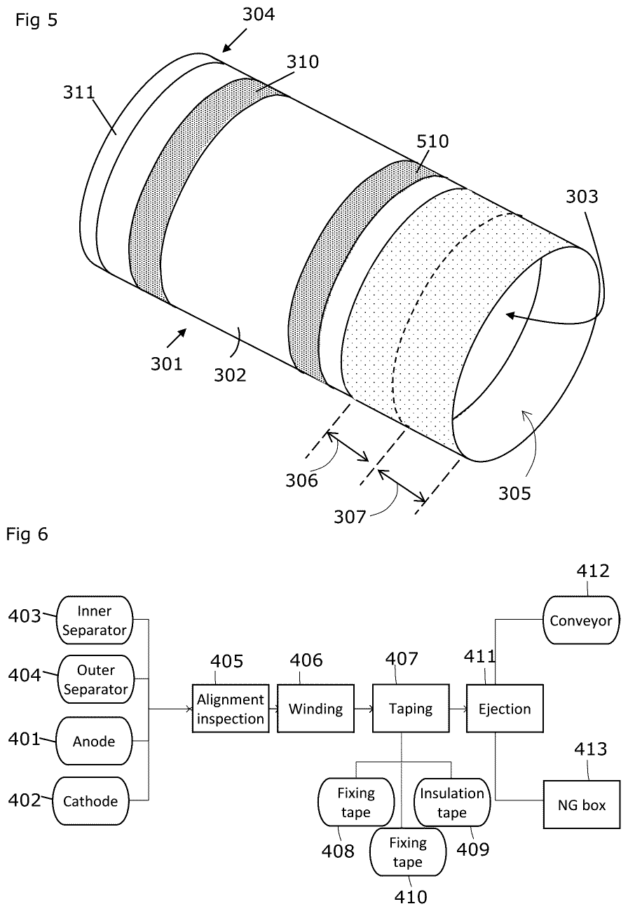

FIGS. 5 and 6 are similar to FIGS. 3 and 4 and therefore only the differences will be described.

In this embodiment, two fixing tapes 310 and 510 are provided. The fixing tape 310 may be termed the first fixing tape and the fixing tape 510 may be termed the second fixing tape. As before, the first fixing tape 310 is applied proximal the second end 304 to prevent unwinding of the jelly-roll at the second end 304.

In this example, the method further includes applying the second fixing tape 510 around the cylindrical body 302 proximal the first end 303 to prevent unwinding of the jelly-roll at the first end in combination with the insulation tape 305.

As shown, the first part 306 of the insulation tape 305 is non-overlapping with the second fixing tape 510. Thus, the second fixing tape 510 may be applied inward of the insulation tape 305 and between the first fixing tape 310 and the insulation tape 305.

In the examples described herein, the first part 306 of the insulation tape 303 is non-overlapping with the one or more fixing tapes 310, 510. However, in other examples (not shown), the insulation tape 305 may be applied over or under, in an overlapping configuration with, the one or more fixing tapes 310, 510.

The example process flow diagram of FIG. 6 is substantially similar to FIG. 4 and the same reference numerals have been used. However, in this example, the tape application process 407 receives the first fixing tape 408, the second fixing tape 410 and the insulation tape 409.

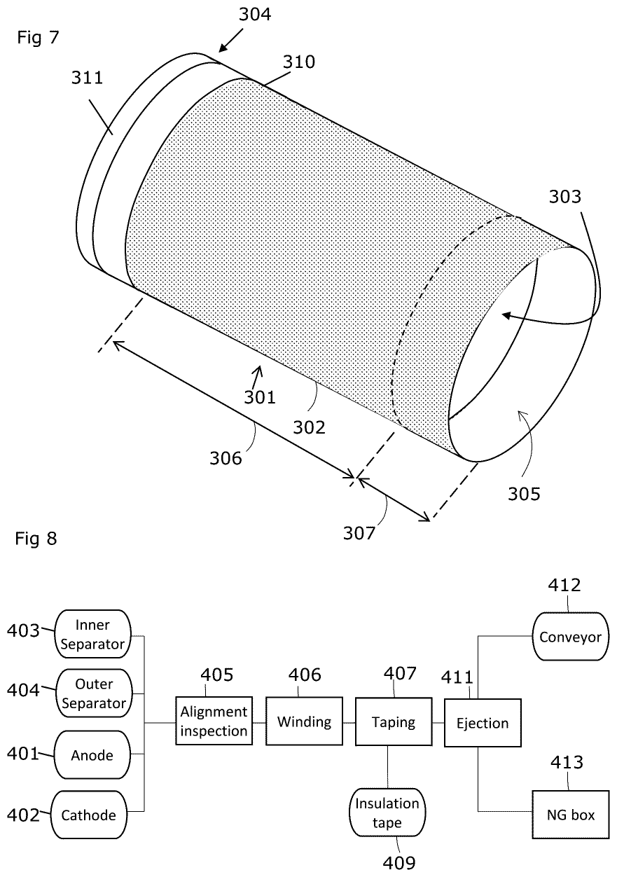

FIGS. 7 and 8 are similar to FIGS. 3 & 4 and 5 & 6 and therefore only the differences will be described.

In this embodiment, no fixing tapes 310, 510 are provided. Thus, the insulation tape 305 is configured to prevent unrolling of the jelly-roll 302. In the present example, the insulation tape 305 is wider than the previous embodiments. As such the first part 306 of the insulation tape 305 extends over approximately 90% of the cylindrical body of the jelly-roll 301.

However, it has been found the resistance against unwinding may be achieved by applying the insulation tape 305 such that the first part 306 extends over 30% to 100% of the length of the cylindrical body 302 of the jelly-roll, or preferably 50% to 100% of the cylindrical body, or preferably 70% to 100% of the cylindrical body.

FIG. 8 shows the tape application process 407 receives only the insulation tape 409.

Further, process step 412 may be simplified as the jelly-roll with the substantial covering of the insulation tape may be placed on the conveyor and transported to further cell assembly processes.

FIG. 9 shows a step subsequent to step 412 in which the electrically conductive cathode disc 108 is welded to the one or more cathode layer connectors and the overhanging second part 307 is folded or crimped radially inwardly to at least partially cover the conductive cathode disc 108. Thus, a circumferential, annular portion 901 of the conductive cathode disc 108 has the electrically insulation tape 305 extending across its surface.

In one or more examples, the annular portion 901 may extend inwardly from the circumference of the first end by up to or at least 5% of the radius of the jelly-roll, or between 5% and 95% of the radius of the jelly-roll, or between 5% and 80%. The uninsulated central part 903 may allow for welding of the cathode disc 108 to the rivet 107.

The provision of the electrically insulating insulation tape 305 extending across part of the electrically conductive cathode disc 108 may obviate the need for one or more of the first end components 106 described in relation to the known design. For example, the insulator disc 110 may not be required because the folded insulation tape 305 provides sufficient electrical insulation.

Thus, once the jelly-roll assembly 902 is formed, the method may include inserting the jelly-roll assembly 902 into a can without further electrical insulation provided between the electrically insulated circumferential portion 901 of the cathode disc and the can. Thus, upon folding the tape, the larger coverage area of the circumferential portion 901, perhaps up to a central riveting position, may enable the elimination the cathode disc insulator 110 and associated process step. In some examples, the folded insulation tape may be configured to cover the entire area of the electrically conductive cathode disc 108 apart from a region to enable welding of the rivet 107.

Alternatively, in a further embodiment, the method may include inserting the jelly-roll into a can with the cathode disc insulator 110 between the electrically conductive cathode disc and the can 101. However, in this example, a simpler design of cathode disc insulator 110 may be provided. For example, with the insulation tape 305 insulating the edge between the cylindrical part and the first end, the cathode disc insulator 110 may not be required to insulate the cylindrical body 103 adjacent the first end 104.

As an alternative to process illustrated in FIG. 9, the second part 307 may be folded over at least part of, or at least some of, the one or more cathode layer connectors and, subsequently, the electrically conductive cathode disc 108 may be welded to at least the cathode layer connectors not covered by the folded second part 307. Thus, in this example, the electrical insulation, by the folded second part 307, of the one or more cathode layer connectors makes it easier to transport the jelly-roll for the step of cathode disc welding.

Thus, provision of the folded insulation tape 305, in either process, has advantages for handling jelly-roll assembly 902 in subsequent assembly steps. FIG. 10 shows the jelly-roll assembly 902 received within a holder 1000 standing vertically on its first end 303. This brings in space savings from previous solutions of laying the jelly-rolls horizontally in trays.

The holder 1000 may be a single holder or part of a tray comprising a plurality of holders. The holder comprises a base 1001 and side walls 1002. The base 1001 within the holder 1000 may include a peripheral ridge 1003, which is configured to contact the folded second part 307. Accordingly, the uninsulated central part 903 sits over a void 1004 in the base 1001.

The jelly-roll assembly may then be transported in the holder 1000 for subsequent assembly steps.

Thus, for example, the method of assembly may include:
receiving the tray comprising the holder 1000 and any other holders;
inserting the jelly-roll assembly 902, comprising the jelly-roll 301 with the folded insulation tape 305, into the holder 100, such that it stands on its first end within the holder and at least the second part of the insulation tape electrically insulates the one or more cathode layer connectors or cathode disc from the holder;
transporting the jelly-roll in the tray to one or more subsequent assembly steps; and wherein the subsequent assembly step(s) include:
removing the jelly-roll assembly 902 from the holder 1000; and, optionally,
welding the electrically conductive cathode disc 108 to the one or more cathode layer connectors or performing an alternative process step.

According to a further aspect of the disclosure we provide a battery cell comprising the jelly-roll 301 comprising an anode layer, a cathode layer and at least one separator layer between the anode and cathode layer. As described, the jelly-roll 301 comprises the substantially cylindrical body 302 having the first end 303 at which one or more cathode layer connectors project that couple to the cathode layer and the opposed, second end 304; and at least the insulation tape 305, comprising an electrically insulating tape, around the cylindrical body 302 such that the first part 306 of the insulation tape winds around the cylindrical body 302 to, at least in part, hold the jelly-roll 302 in a rolled state, and the second part 307 of the insulation tape 305 is folded to at least partially cover the first end 303.

A jelly-roll may also be of a tab-less design. Thus, the cathode layer connectors may not comprise a plurality of tabs. In tab-less cells, the conductive anode and cathode layers commonly have an exposed (i.e., uncoated) part protruding from one side of the cylindrical body. The exposed part is for connection to a terminal of the cell to allow the flow of an electrical current from the jelly-roll via the terminal. The same process may be applied for tab-less jelly-rolls.

An aspect of the disclosure may comprise a vehicle including a battery system comprising one or more of the battery cells described herein or one or more battery cells assembled by the method described herein. The vehicle may comprise a battery electric vehicle and the battery system may be configured to provide motive power. A further aspect of the disclosure may comprise a battery system comprising one or more of the battery cells described herein or one or more battery cells assembled by the method described herein, wherein the battery system comprises a battery energy storage system, such as grid-connected battery energy storage system. In other examples, the battery system comprises part of a trailer or roof-box for coupling to a vehicle.

The instructions and/or flowchart steps in the above figures can be executed in any order, unless a specific order is explicitly stated. Also, those skilled in the art will recognize that while one example set of instructions/method has been discussed, the material in this specification can be combined in a variety of ways to yield other examples as well, and are to be understood within a context provided by this detailed description.

In one example, one or more instructions or steps discussed herein are automated. Thus, performing the method may include controlled operation of an apparatus, system, and/or process using computers and/or mechanical/electrical devices without the necessity of human intervention, observation, effort and/or decision.

It will be appreciated that any components said to be coupled may be coupled or connected either directly or indirectly. In the case of indirect coupling, additional components may be located between the two components that are said to be coupled.

In this specification, example embodiments have been presented in terms of a selected set of details. However, a person of ordinary skill in the art would understand that many other example embodiments may be practiced which include a different selected set of these details. It is intended that the following claims cover all possible example embodiments.

1. A method of assembling a battery cell comprising:
receiving a jelly-roll comprising an anode layer, a cathode layer and at least one separator layer between the anode and cathode layer, the jelly-roll comprising a substantially cylindrical body having a first end, at which one or more cathode layer connectors project that couple to the cathode layer, and a second end, opposed the first end;
applying at least an insulation tape, comprising an electrically insulating tape, around the cylindrical body such that a first part of the insulation tape winds around the cylindrical body to, at least in part, hold the jelly-roll in a rolled state, and a second part of the insulation tape overhangs the first end; and
folding the second part of the insulation tape to at least partially cover the first end.

2. The method of claim 1, wherein receiving the jelly-roll comprises:
winding, with a winding apparatus, a layered assembly of the anode layer, the cathode layer and the at least one separator layer to form the jelly-roll; and
wherein applying at least the insulation tape comprises wrapping the first part of the insulation tape around the cylindrical body.

3. The method of claim 1, wherein the first part of the insulation tape extends over 30% to 100% of the cylindrical body of the jelly-roll.

4. The method of claim 2, wherein receiving the jelly-roll further includes applying one or more fixing tapes around cylindrical body after the winding of the layered assembly to prevent unwinding of the jelly-roll, wherein the one or more fixing tapes are of a different material to the insulation tape.

5. The method of claim 4, wherein the insulation tape and the one or more fixing tapes are unwound from respective spools and applied to the jelly-roll concurrently.

6. The method of claim 4, wherein the one or more fixing tapes comprise one fixing tape and the method comprises applying said one fixing tape around the cylindrical body proximal the second end to prevent unwinding of the jelly-roll.

7. The method of claim 4, wherein the method comprises:
applying a first fixing tape of the one or more fixing tapes around the cylindrical body proximal the second end to prevent unwinding of the jelly-roll;
applying a second fixing tape of the one or more fixing tapes around the cylindrical body proximal the first end to prevent unwinding of the jelly-roll; and
wherein the first part of the insulation tape is non-overlapping with the second fixing tape.

8. The method of claim 4, wherein the first part of the insulation tape is non-overlapping with the one or more fixing tapes that prevent unwinding of the jelly-roll.

9. The method of claim 1, wherein the method comprises, prior to folding the second part, welding an electrically conductive cathode disc to the one or more cathode layer connectors; and, wherein the folding of the second part of the insulation tape comprises folding the second part of the insulation tape over the cathode disc to electrically insulate at least a circumferential portion of the cathode disc.

10. The method of claim 9, comprising, after the folding of the second part of the insulation tape over the cathode disc, inserting the jelly-roll into a can without further electrical insulation provided between the electrically insulated circumferential portion of the cathode disc and the can.

11. The method of claim 9, comprising, after the folding of the second part of the insulation tape over the cathode disc, inserting the jelly-roll into a can with a cathode disc insulator between the electrically conductive cathode disc and the can.

12. The method of claim 1, wherein the method comprises, after folding the second part, welding an electrically conductive cathode disc to the one or more cathode layer connectors that are uncovered by the folded second part.

13. The method of claim 1, comprising:
receiving a tray comprising one or more holders, each holder configured to receive a respective jelly-roll and defined by a base and one or more side walls; and
inserting the jelly-roll into a respective one of the one or more holders, such that it stands on its first end within the holder and at least the second part of the insulation tape electrically insulates the one or more cathode layer connectors from the holder; and
transporting the jelly-roll in the tray to a subsequent assembly step.

14. The method of claim 13, wherein the subsequent assembly step includes:
removing the jelly-roll from the holder; and
welding an electrically conductive cathode disc to the one or more cathode layer connectors.

15. The method of claim 4, wherein at least one of: the one or more fixing tapes are of polypropylene and the insulation tape is of polyimide.

16. The method of claim 2, wherein the method comprises applying the insulation tape with the winding apparatus that wound the layered assembly to form the jelly-roll.

17. The method of claim 1, wherein the folding of the second part is such that the second part of the insulation tape is folded to lie substantially perpendicular to an axis of the jelly-roll.

18. A battery cell comprising:
a jelly-roll comprising an anode layer, a cathode layer and at least one separator layer between the anode and cathode layer, the jelly-roll comprising a substantially cylindrical body having a first end at which one or more cathode layer connectors project that couple to the cathode layer and a second end, opposed the first end; and
at least an insulation tape, comprising an electrically insulating tape, around the cylindrical body such that a first part of the insulation tape winds around the cylindrical body to, at least in part, hold the jelly-roll in a rolled state, and a second part of the insulation tape is folded to at least partially cover the first end.

19. A vehicle including a battery system comprising one or more battery cells, wherein each of the one or more battery cells comprises:
a jelly-roll comprising an anode layer, a cathode layer and at least one separator layer between the anode and cathode layer, the jelly-roll comprising a substantially cylindrical body having a first end at which one or more cathode layer connectors project that couple to the cathode layer and a second end, opposed the first end; and
at least an insulation tape, comprising an electrically insulating tape, around the cylindrical body such that a first part of the insulation tape winds around the cylindrical body to, at least in part, hold the jelly-roll in a rolled state, and a second part of the insulation tape is folded to at least partially cover the first end.

20. A battery system comprising one or more battery cells, wherein each of the one or more battery cells comprises:
a jelly-roll comprising an anode layer, a cathode layer and at least one separator layer between the anode and cathode layer, the jelly-roll comprising a substantially cylindrical body having a first end at which one or more cathode layer connectors project that couple to the cathode layer and a second end, opposed the first end; and
at least an insulation tape, comprising an electrically insulating tape, around the cylindrical body such that a first part of the insulation tape winds around the cylindrical body to, at least in part, hold the jelly-roll in a rolled state, and a second part of the insulation tape is folded to at least partially cover the first end.
